(19) United States
(12) Patent Application Publication
(10) Pub. No.: US 2025/0207211 A1
(43) Pub. Date: Jun. 26, 2025

(54) REDUCTION OF A METAL OXIDE-CONTAINING MATERIAL ON THE BASIS OF AMMONIA NH3

(71) Applicant: Primetals Technologies Austria GmbH, Linz (AT)

(72) Inventors: Alexander FLEISCHANDERL, Gruenau (AT); Robert MILLNER, Loosdorf (AT); Bernd WEISS, Linz (AT)

(21) Appl. No.: 18/848,853

(22) PCT Filed: Mar. 29, 2023
(86) PCT No.: PCT/EP2023/058112

§ 371 Date: Sep. 19, 2024

(30) Foreign Application Priority Data
Mar. 30, 2022 (EP) 22165598.8
Sep. 7, 2022 (EP) 22194331.9

(51) Int. Cl. C21B 5/00; B01J 8/18; C21B 7/00; C21B 7/10

(52) U.S. Cl. CPC C21B 5/001; B01J 8/1809; B01J 8/1827; B01J 8/1836; C21B 7/002; C21B 7/10; B01J 2208/00371; B01J 2208/00725; B01J 2208/00991; C21B 2005/005; C21B 2100/64

(57) ABSTRACT

A method for the reduction of a metal oxide-containing material in which a reducing gas that is obtained using ammonia (NH₃) is used. The reducing gas is supplied to a reduction reactor containing the metal oxide-containing material, and a top gas is discharged from the reduction reactor. At least one sub-quantity of the top gas is used as components in the preparation of the reducing gas, optionally after the top gas is prepared. A device for the reduction of the metal oxide-containing material that includes a reduction reactor, a top gas discharge line for discharging top gas, a supply line for an ammonia contribution, a preparation system for preparing the reducing gas, a supply line for the ammonia contribution leading into the preparation system, and a feed line for feeding the reducing gas and/or a precursor of the reducing gas to the reduction reactor.

### TECHNICAL FIELD

The application relates to a process and device for reducing metal-oxide-containing material,
wherein a reducing gas obtained with the use of ammonia NH₃ is employed.

### PRIOR ART

It is known that metal-oxide-containing material, for example iron-oxide-containing material, for example ores, can be reduced using a reducing gas. For instance through a direct reduction with a reducing gas in a reduction unit, for example a reduction shaft, or else in a blast furnace process in which carbon monoxide CO, for example, acts as a reducing gas in the reduction unit of the blast furnace. In conventional processes currently used on an industrial scale, the reducing gas is predominantly based on natural gas. A large amount of carbon dioxide CO₂ therefore arises, which is undesirable for environmental and other reasons.

A known way of lowering CO₂ emissions in the reduction of metal-oxide-containing material is to use hydrogen H₂ as reducing gas. Hydrogen can be used here as the sole reducing gas or it can be used in combination with other gases, for example natural-gas-based reducing gases. The greater the fraction of CO₂-neutral hydrogen H₂ in the reducing gas, the less CO₂ is emitted.

However, the storage of hydrogen H₂ and transport to consumers from the place of its generation is problematic and associated with high costs on account of its physical properties.

Another known way of lowering CO₂ emissions in the reduction of metal-oxide-containing material is to employ ammonia NH₃ as a reductant. Ammonia offers significant advantages over hydrogen H₂ in its storage and transport.

Ammonia can be cleaved into nitrogen and hydrogen

2NH₃→N₂+3H₂.

Hydrogen H₂ can react as a reductant with the metal oxides, for example iron oxides:

3Fe₂O₃+H₂→2Fe₃O₄+H₂O

Fe₃O₄+H₂→3FeO+H₂O

FeO+H₂→Fe+H₂O.

However, ammonia can itself also act as a reductant:

9Fe₂O₃+2NH₃→6Fe₃O₄+N₂+3H₂O

3Fe₃O₄+2NH₃→9FeO+N₂+3H₂O

3FeO+2NH₃→3Fe+N₂+3H₂O.

Reducing gas obtained with the use of ammonia NH₃ can thus in principle be employed for the reduction of metal-oxide-containing material; such a reducing gas may be for example ammonia NH₃ or a mixture of ammonia NH₃ with one or more other gases, preferably one or more gases able to act as a reductant on metal-oxide-containing material, which would be the case with for example a mixture of ammonia and its cleavage products hydrogen H₂ and nitrogen N₂, although other gases could of course be present in the mixture too. However, the reducing gas obtained with the use of ammonia NH₃ may also be a reducing gas that does not contain ammonia NH₃, but comprises the cleavage product hydrogen H₂ obtained from a cleavage process, alone or together with the cleavage product nitrogen N₂, optionally in a mixture with one or more other gases, preferably one or more gases able to act as a reductant on metal-oxide-containing material.

Such reduction reactions for the production of metallic iron Fe with hydrogen H₂ and with ammonia NH₃ are endothermic, as is the cleavage of ammonia into nitrogen N₂ and hydrogen H₂. There is therefore the problem as to how sufficient amounts of energy can be supplied in a resource-conserving manner to a process involving such reactions if employed industrially.

The cleavage of ammonia and its action as a reductant gives rise not just to hydrogen H₂, but also to significant amounts of nitrogen N₂. There is therefore the problem as to how the nitrogen that arises can be utilized in a manner that is beneficial to the process if employed industrially.

### SUMMARY OF THE INVENTION

### Technical Object

The object of the present invention is to provide a contribution to solving at least some of the problems mentioned above.

### Technical Solution

The object is achieved by a
process for reducing metal-oxide-containing material,
wherein a reducing gas obtained with the use of ammonia NH₃ is employed,
wherein the reducing gas is supplied to a reduction reactor containing the metal-oxide-containing material,
and a top gas is discharged from the reduction reactor, characterized in that
at least a part-amount of the top gas, optionally after a treatment of the top gas,
is used as a component in the preparation of the reducing gas.

The metal-oxide-containing material is preferably an iron-oxide-containing material.

The reduction process is for example a direct reduction process.

The reducing gas is obtained with the use of ammonia NH₃. Such a reducing gas may be for example ammonia NH₃ or a mixture of ammonia NH₃ with one or more other gases, preferably one or more gases able to act as a reductant on metal-oxide-containing material, which would be the case with for example a mixture of ammonia and its cleavage products hydrogen H₂ and nitrogen N₂, although other gases could of course be present in the mixture too. However, the reducing gas obtained with the use of ammonia NH₃ may also be a reducing gas that does not contain ammonia NH₃, but comprises the cleavage product hydrogen H₂ obtained from a cleavage process, alone or together with the cleavage product nitrogen N₂, optionally in a mixture with one or more other gases, preferably one or more gases able to act as a reductant on metal-oxide-containing material.

The reducing gas may thus comprise ammonia and may consist partly or entirely of ammonia.

When it consists only partly of ammonia, it will contain further components; one aspect of the use of ammonia is then the mixing with the further components; for example, ammonia may be added to the further components such that it makes up more than 0.5% by volume of the gas stream obtained after it has been admixed. Possible further components can be either ones that under the conditions prevailing in the reduction reactor are inert in respect of reactions with the metal-oxide-containing material, for example nitrogen N₂, and ones that under the conditions prevailing in the reduction reactor react with the metal-oxide-containing material. Preference in this regard is given to components acting as a reductant on the metal-oxide-containing material; these can be for example hydrocarbon-containing gases, carbon-containing gases, hydrogen-containing gases or hydrogen. Reducing gas can also be obtained with the use of ammonia, by cleaving ammonia and mixing the gas mixture of nitrogen and hydrogen that is formed with further components of the reducing gas, optionally after an enrichment or depletion of nitrogen or hydrogen.

Reducing gas can also be obtained with the use of ammonia, by cleaving ammonia and mixing the hydrogen that is formed, after removal of nitrogen, with further components of the reducing gas, or by providing the reducing gas in its entirety, possibly with residual small amounts of nitrogen formed during the cleavage.

Ammonia of any “color” is in principle suitable. “Color” is to be understood here to mean the color associated with the underlying production mode. Often, the color of the ammonia is associated with the color of the hydrogen used in production. The ammonia may for example be green when produced using green hydrogen, for example, or it may be blue for example when produced using hydrogen obtained with sequestration of carbon dioxide CO₂ that has formed. The ammonia can also be produced using turquoise hydrogen, for example when the hydrogen is produced by removing carbon C that has formed, and it can be produced using pink hydrogen, for example when the hydrogen is produced using atomic power. A mixture composed of ammonia having one or more of these “colors”, that is to say where the hydrogen used to produce the ammonia is of a mixture of colors, is also possible.

The reducing gas is the gas introduced into the reduction reactor in which the reduction reactions take place—the reactor interior containing the metal-oxide-containing material—and having the composition and temperature present on its introduction. Prior to this composition and temperature, a reducing gas precursor is present that is the basis for the preparation of the reducing gas. Said preparation can be effected for example by adding further components or heating. Said preparation can also be effected through chemical reactions taking place in the precursor without external intervention, chemical reactions that for example alter the chemical composition or the temperature.

The reduction reactor is for example a reduction shaft, for example when carrying out a direct reduction process using a reduction shaft containing a fixed bed of metal-oxide-containing material. The reduction reactor is for example a fluid-bed reactor, for example when carrying out a direct reduction process using a reduction reactor containing a fluid bed of metal-oxide-containing material. The fluid-bed reactor may here also comprise a plurality of individual sub-reactors that are for example connected in parallel or in sequence and together form the fluid-bed reactor.

The reduction reactor is for example a fluidized-bed reactor, for example when carrying out a direct reduction process using a reduction reactor containing a fluidized bed of metal-oxide-containing material. The fluidized-bed reactor may here also comprise a plurality of individual sub-reactors that are for example connected in parallel or in sequence and together form the fluidized-bed reactor.

The reduction reactor may also be a blast furnace that contains a fixed bed comprising a metal-oxide-containing material-when operating a blast furnace, ammonia can for example replace PCI coal or fossil reducing gases.

A top gas is discharged from the reduction reactor. The top gas is formed from the reducing gas as it flows through the reduction reactor, as a result of its components undergoing reactions in the reduction reactor with the metal-oxide-containing material or with the products formed in these reactions, for example the metallic iron that is formed. The reduction reactions that take place in the reduction reactor result in the top gas having less reducing power than the reducing gas.

Use is made of at least a part-amount of the top gas as a component in the preparation of the reducing gas, optionally after a treatment. Use is made of a part-amount either when, where the composition of the top gas is unchanged, only a part-amount of the resulting top gas volume is utilized, or when not all constituents of the resulting top gas are used, i.e. for example when an enrichment of a constituent, for example enrichment of hydrogen, takes place and the correspondingly enriched gas stream is used in its entirety or in part.

One step in the preparation of the reducing gas is therefore—when no treatment is carried out—the mixing of top gas with further components of the reducing gas; either the gas mixture thereby obtained forms the reducing gas or the reducing gas is prepared on the basis of said gas mixture, with further steps being performed, for example admixing additional components or heating to the temperature required for introduction into the reduction reactor, or chemical reactions resulting in a change in composition.

The top gas is optionally subjected to a treatment.

The treatment may comprise one or more steps. Examples of possible steps are:
removing dust, which can be carried out dry or wet,
cooling,
adjusting the water vapor content to a desired level, if necessary by cooling,
compressing,
heating,
desulfurizing, for example in the reduction of sulfur-containing material, especially when a reformer is used for the preparation of the reducing gas.

The dust removal step is preferably carried out dry, since this allows the process to make better use of the heat content of the gas compared with wet dust removal. For example, the heat can be utilized to vaporize the ammonia. The heat can also be utilized elsewhere in the process—optionally via a heat transfer medium—for example for the generation of hot water and/or steam.

Adjusting the water vapor content to a desired level is advantageous for example when natural gas is reformed with water vapor in a reformer during the preparation of the reducing gas. Adjusting the water vapor content to a desired level is also advantageous because it influences the reducing gas quality, expressed as the ratio of the percent by volume contents of carbon monoxide CO, hydrogen H₂, carbon dioxide CO₂, water H₂O (CO+H₂)/(CO₂+H₂O) and of hydrogen H₂ and water H₂O H₂/H₂O.

The gas obtained after the treatment step(s) is in the context of the present application referred to as treatment gas.

When top gas is treated, treatment gas is used as a component in the preparation of the reducing gas; top gas is in this case thus used indirectly in the preparation of the reducing gas via the treatment gas obtained on the basis of the top gas. One step in the preparation of the reducing gas is in this case the mixing of the treatment gas with further components of the reducing gas; either the gas mixture thereby obtained forms the reducing gas or the reducing gas is prepared on the basis of said gas mixture, with further steps being performed, for example admixing additional components or heating to the temperature required for introduction into the reduction reactor, or chemical reactions resulting in a change in composition.

### Advantageous Effects of the Invention

Although the top gas, as a consequence of the reduction reactions taking place in the reduction reactor, has less reducing power than the reducing gas, it still contains reducing components, such as hydrogen H₂ and its reducing power is not yet exhausted. It also has an energy content on account of its temperature.

It is advantageous to make use of the reducing power still present in the top gas for the reduction process. It is also advantageous to utilize the energy content for the reduction process; with increasing utilization, the additional energy needed for heating steps to adjust the reducing gas to the required temperature falls.

Especially in the case of endothermic reactions taking place in the reduction reactor, the supply of energy to the reduction reactor is important in order to maintain the reactions. The energy can be supplied via the reducing gas and be altered for example by the amount and temperature of reducing gas supplied. In the direct reduction of iron oxides, it is preferable when the reducing gas has a temperature above 750° C., more preferably above 800° C. When using a reducing gas that reduces only on the basis of hydrogen H₂ and/or ammonia NH₃ it is preferable, for example in the direct reduction of iron oxides, when the specific amount of reducing gas introduced into the reduction reactor is above 2000 Nm³/ton of direct reduced iron DRI, preferably above 2200 Nm³/t DRI. For example, when a reducing gas is used that also contains natural-gas-based reducing components, a lower value is preferable, for example 1500-1600 Nm³/t DRI.

Utilization of the top gas—directly as top gas and/or indirectly via treatment gas obtained on the basis of the top gas—for the preparation of the reducing gas permits utilization of the reducing potential remaining in the top gas and the utilization of the heat content of the top gas.

The nitrogen present in the top gas can be utilized in the process as a heat-transfer medium. Despite the nitrogen being inert in respect of the reduction reactions, it contributes in this way to the resource-conserving performance of the process. Energy that is transferred to the reduction reactor by nitrogen via its heat content does not need to be introduced into the reduction reactor by other substances; for example, not by the components of the reducing gas that have a reducing potential. These components, for example ammonia NH₃, hydrogen H₂, hydrocarbons, are more costly and more laborious to provide than nitrogen N₂, which is in any case produced in the cleavage of ammonia NH₃—one part by volume of nitrogen N₂ for every 3 parts by volume of hydrogen H₂—and therefore do not necessarily need to be used in an overly high stoichiometric excess. These components should be used primarily for reducing purposes; the use thereof purely to provide an input of heat without making a significant contribution to reaction conversion is costly and less resource-conserving compared to the use of nitrogen.

In one embodiment, the treatment of the top gas withdrawn from the reduction reactor includes a process step to lower the nitrogen content.

The top gas is here subjected to a treatment that includes at least a lowering of the nitrogen content of the top gas. This treatment does not remove the nitrogen entirely. The lowering is carried out in order to slow the enrichment of the reducing gas with nitrogen that results from the use of the top gas and the associated decrease in the reducing power of the reducing gas.

Examples of suitable ways of lowering the nitrogen content include methods making use of differing permeation rates, methods making use of differing adsorption powers, and methods making use of differing boiling temperatures for the graded liquefaction of individual fractions. Combinations of more than one of these methods are also possible.

Examples of such methods include membrane separation, for example using hollow-fiber membranes or using separation membranes based on porous graphene or using single- or multi-stage inorganic membranes, methods such as pressure swing adsorption (PSA), and methods such as cryogenic distillation. A resulting gas stream with an increased nitrogen content can be recycled, for example thermally in a reducing gas furnace or in a reformer. The resulting gas stream, which on account of the removal of inert nitrogen has an increased content of reducing components, for example an increased hydrogen content, is used in the preparation of the reducing gas.

The lowering of the nitrogen content is advantageously under closed-loop control such that the reducing gas contains less than 40% by volume, preferably less than 30% by volume, more preferably less than 20% by volume, of nitrogen.

Although the amount of nitrogen present in the top gas is lowered during the treatment of the top gas, the treatment gas still contains residual nitrogen. This provides a means of making use of the heat content of this nitrogen in the process. Despite this nitrogen being inert in respect of the reduction reactions, it contributes in this way to the resource-conserving performance of the process.

It is also possible for the nitrogen content in the reducing gas to be subject to open-loop and/or closed-loop control at a set value through the part-amount in the top gas—optionally after treatment of the top gas—that is not used as a component in the preparation of the reducing gas being subject to a corresponding open-loop and/or closed-loop control. This part-amount is discharged from the reducing gas preparation cycle; the discharged gas can be utilized thermally, for example in a gas furnace, reducing gas furnace or a reformer. It is preferable when the discharge gas is discharged after cooling the top gas.

In one embodiment, at least one member of the first group consisting of:
ammonia, which may be used in either liquid or gaseous form
hydrogen obtained from ammonia, for example in the form of pure hydrogen or in a mixture of nitrogen N₂ and hydrogen H₂
   is added to the top gas and/or to the treatment gas during the preparation of the reducing gas.

Thus, one or more members of the first group may be added to the top gas and/or to the treatment gas.

The ammonia is preferably added in gaseous form.

The ammonia can be heated before it is added, for example electrically. For example, it can be heated by means of a gas furnace, wherein the gas furnace can be heated for example with electrical energy or by burning fuels. In the first group the hydrogen is obtained from ammonia, which means it is ammonia-based hydrogen. This includes the addition of said hydrogen as a constituent of a gas mixture, for example a gas mixture of nitrogen and hydrogen formed in the cleavage of ammonia.

In one embodiment, at least one member of the second group consisting of:
natural gas
hydrocarbons, for example ethane C₂H₆, propane C₃H₈, butane C₄H₁₀,
hydrogen,
carbon monoxide,
coke oven gas,
syngas comprising two or more constituents from the group of constituents consisting of
   CO, H₂, CH₄, C2-C6 hydrocarbons, N₂, CO₂.
   is added to the top gas and/or to the treatment gas during the preparation of the reducing gas.

This is hydrogen obtained from sources other than ammonia, i.e. it has not been obtained from ammonia and is thus non-ammonia-based hydrogen. It could for example be green, blue, gray, turquoise or pink hydrogen. These “colors” are to be understood here to mean the colors associated with the underlying mode of production. Green hydrogen is produced for example through the electrolysis of water using electricity from renewable energies, or by gasification or fermentation of biomass, or steam reforming of biogas—what is common to all forms of green hydrogen production is that it takes place in a CO₂-free process. In the case of blue hydrogen, CO₂ formed during production is stored such that it does not enter the atmosphere; for example, when produced with sequestration of the carbon dioxide CO₂ that is formed. In the case of turquoise hydrogen, it is produced by removing carbon C that is formed. Pink hydrogen is hydrogen that is produced using atomic power. A mixture of hydrogen having one or more of these “colors” can also be considered. Gray hydrogen is produced from fossil fuels, for example from natural gas by steam reforming, the CO₂ that is formed being mostly released into the atmosphere.

Other hydrogen colors can also be considered. A mixture of hydrogen having one or more of these “colors” can also be considered.

Syngas, or synthesis gas, is understood to mean an industrially produced gas mixture that comprises mainly carbon monoxide and hydrogen plus varying amounts of other gases, for example carbon dioxide. Synthesis gas can in principle be produced from solid, liquid, and gaseous input materials. It is for example possible to use various crude oil distillates—low-boiling as well as high-boiling fractions—as liquid input materials for synthesis gas. The most important gaseous reactant for the production of synthesis gas is natural gas.

Examples of methods of production include steam reforming of natural gas or liquid hydrocarbons and gasification of coal, biomass or other residues.

An example of a possible composition of synthesis gas is carbon monoxide CO=41% by volume, carbon dioxide CO₂=14% by volume, hydrogen H₂=34% by volume, methane CH₄=5% by volume, C2-C6 hydrocarbons=2% by volume, nitrogen N₂=4% by volume.

One or more members of the second group may thus be added to the treatment gas.

It is also possible for members of the first or second group to be added to the top gas or to the treatment gas before the start or before the end of the treatment, but if a treatment is being employed it is preferable for an addition to the treatment gas to take place at the end of the treatment.

The concomitant use of green ammonia NH₃ and green hydrogen H₂ is advantageous, since this is particularly cost-effective and allows the CO₂ load of the product of the process to be brought down particularly readily. It is particularly advantageous to increase the amount of green ammonia NH₃ used when the amount of green hydrogen H₂ used needs to be/must be cut, for example for reasons of availability or cost.

The amount of green hydrogen H₂ used can likewise be increased when the amount of green ammonia NH₃ used needs to be/must be cut, for example for reasons of availability or cost.

In one embodiment, at least one member of the second group is added to the gas mixture obtained after combining the top gas or treatment gas and at least one member of the first group. The gas mixture obtained after combining the top gas or treatment gas and at least one member of the first group is a reducing gas precursor; at least one member of the second group is added to this precursor. The resulting gas mixture may be the reducing gas or it may be a reducing gas precursor. When it is a precursor, further steps are performed, for example admixing additional components or heating to the required temperature for introduction into the reduction reactor, or chemical reactions resulting in a change in composition.

Before at least one member of the second group is added to the gas mixture formed after combining the top gas or treatment gas and at least one member of the first group, changes can still be made to this gas mixture, for example admixing additional components or heating or chemical reactions resulting in a change in the composition.

Heating can for example be effected by means of electrically operated heating devices.

Heating can for example be effected indirectly via gas burners; in one variant the offgas that arises here is also used to heat the precursors via heat exchangers. Both natural gas and top gas can for example be used as the basis for the fuel for the gas burners; the use of top gas is favorable, since its chemical energy is utilized within the reduction process.

Chemical reactions resulting in a change in composition can be initiated for example through reforming of the precursor, especially when natural gas is added. Heating in a reformer used for this purpose can for example be effected indirectly via gas burners; in one variant the offgas that arises here is also used to heat the precursors via heat exchangers. Both natural gas and top gas can for example be used as the basis for the fuel for the gas burners; the use of top gas is favorable, since its chemical energy is utilized within the reduction process.

In one embodiment, at least one member of the first group is added to the gas mixture obtained after combining the top gas or treatment gas and at least one member of the second group. The gas mixture obtained after combining the top gas or treatment gas and at least one member of the second group is a reducing gas precursor; at least one member of the first group is added to this precursor. The resulting gas mixture may be the reducing gas or it may be a reducing gas precursor. When it is a precursor, further steps are performed, for example admixing additional components or heating to the required temperature for introduction into the reduction reactor, or chemical reactions resulting in a change in composition.

Before at least one member of the first group is added to the gas mixture formed after combining the top gas or treatment gas and at least one member of the second group, changes can still be made to this gas mixture, for example admixing additional components or heating to the required temperature for introduction into the reduction reactor, or chemical reactions resulting in a change in the composition. Heating can for example be effected by means of electrically operated heating devices. Heating can for example be effected indirectly via gas burners; in one variant the offgas that arises here is also used to heat the precursors via heat exchangers. Both natural gas and top gas can for example be used as the basis for the fuel for the gas burners; the use of top gas is favorable, since its chemical energy is utilized within the reduction process.

Chemical reactions resulting in a change in composition can be initiated for example through reforming of the precursor, especially when natural gas is added. Heating in a reformer used for this purpose can for example be effected indirectly via gas burners; in one variant the offgas that arises here is also used to heat the precursors via heat exchangers. Both natural gas and top gas can be used as the basis for the fuel for the gas burners.

It is possible to add ammonia to the top gas, to the treatment gas, or to precursors of the reducing gas. When using a reduction reactor that has a bustle for introducing reducing gas into the interior containing the metal-oxide-containing material in which the reduction reactions take place, ammonia can be added for example to the gas leading to the bustle.

In one embodiment, a process for reducing metal-oxide-containing material is carried out in a reduction reactor having a cooling zone and/or a product cooler,
this being characterized in that
ammonia is introduced into the cooling zone of the reduction reactor and/or into the product cooler.

The ammonia is preferably introduced here in gaseous form. The ammonia is cleaved in the reduction reactor, the reactions that occur being predominantly endothermic. Cleavage takes place even in the cooling zone. Ammonia introduced into the cooling zone thus contributes firstly to cooling, since it undergoes an endothermic cleavage, and secondly to reduction reactions in the reduction reactor.

The cooling by ammonia can be subject here to closed-loop control such that, for example, the temperature of the reduced material withdrawn from the reduction reactor is the target temperature for further processing. For example, if the hot DRI (HDRI) withdrawn from the reduction reactor is subsequently compacted, the target temperature may be different to that required for supply to an EAF.

The invention further provides a
device for reducing metal-oxide-containing material, comprising:
   a reduction reactor,
   a top gas discharge line for discharging top gas from the reduction reactor,
   at least one inlet line for the ammonia input,
   a preparation unit for preparing the reducing gas, into which leads at least one inlet line for the ammonia input,
   a supply line for the supply of the reducing gas and/or of a reducing gas precursor to the reduction reactor,
characterized in that
the top gas discharge line leads into the preparation unit.

The device for reducing metal-oxide-containing material may comprise one or more reduction reactors.

The device for reducing metal-oxide-containing material ma y comprise one or more top gas discharge lines.

The device for reducing metal-oxide-containing material may comprise one or more inlet lines for the ammonia input; these are suitable for adding liquid ammonia, or suitable for adding gaseous ammonia, or suitable for adding either liquid ammonia or gaseous ammonia, or suitable for adding hydrogen H₂ obtained from ammonia by cleavage—pure or in a mixture with nitrogen N₂.

The device for reducing metal-oxide-containing material may comprise one or more supply lines.

Such a device allows ammonia NH₃ to be used in order to obtain reducing gas. The reducing gas is prepared in the preparation unit with the use of ammonia NH₃. The preparation unit may to this end comprise one or more cleavage units for the cleavage of ammonia. The preparation unit may to this end also comprise one or more mixing devices that mix the liquid or gaseous ammonia and/or at least one of its cleavage products hydrogen H₂ and nitrogen N₂ with further components; they may also mix mixtures of the cleavage products with further components. The preparation unit may also comprise one or more component inlet lines for the supply of components used in the preparation of the reducing gas. The preparation unit may also comprise one or more separating devices for separating the gas mixture of hydrogen H₂ and nitrogen N₂ obtained in the cleavage of ammonia; separation is to be understood here to mean not just full separation, but also enrichment or depletion of hydrogen H₂ and nitrogen N₂. For example, in the preparation unit an inlet line for the ammonia input may lead into a top gas conduit, where the point at which this occurs is to be understood to mean a mixing device. Thus, reducing gas can be prepared with the use of ammonia and top gas as a component.

For example, in the preparation unit an inlet line for the ammonia input may lead into a treatment gas conduit, where the point at which this occurs is to be understood to mean a mixing device. In this way, reducing gas may be prepared with the use of ammonia and treatment gas as a component.

For example, in the preparation unit an inlet line for the ammonia input may lead into a reducing gas precursor conduit, where the point at which this occurs is to be understood to mean a mixing device. In this way, reducing gas may be prepared with the use of ammonia.

When, for example, a reduction reactor with bustle is used, the reduction reactor or its bustle is supplied via the supply line with reducing gas formed by adding ammonia to a top gas conduit via an inlet line for the ammonia input. The supply line serves here also as a preparation unit and mixing device, since the top gas and ammonia mix as they flow through the line and prepare the reducing gas.

The supply line may also be part of the preparation unit in another way, for example when feed lines for feeding additional components into the precursor gas lead into the supply line, or when heating devices are present in the supply line.

The preparation unit optionally includes devices for heating ammonia, in order that ammonia may be heated before being added to top gas and/or treatment gas.

The top gas discharge line optionally includes one or more treatment units, in which case treatment gas is supplied to the preparation unit through the top gas discharge line. The treatment units may be for example a dust removal device (dry or wet dust removal) or a cooling device, or a compression device, or a heating device, or a cooling device, or a device for adjusting the water vapor content, or a desulfurization device. It is also possible for a treatment unit to fulfill more than one treatment function, for example a cooling device can also act as a device for adjusting the water vapor content.

In a preferred embodiment, the top gas discharge line includes at least one treatment unit that is a device for lowering the nitrogen content. This allows the nitrogen content of the top gas to be lowered and a treatment gas having a lowered nitrogen content compared to the top gas to be provided.

The device may for example be a device for lowering the nitrogen content on the basis of differing permeation rates, a device for lowering the nitrogen content by making use of differing adsorption forces, for example pressure swing adsorption, or a device for lowering the nitrogen content by making use of differing boiling temperatures.

In a preferred embodiment, the preparation unit includes at least one feed line for feeding in one or more members of the group consisting of:
natural gas
hydrocarbons, for example ethane C₂H₆, propane C₃H₈, butane C₄H₁₀,
hydrogen,
carbon monoxide,
coke oven gas,
syngas.

Thus, for example, the feed line may be a natural gas feed line, a hydrogen feed line, a carbon monoxide feed line, a coke oven gas feed line, a syngas feed line or a hydrocarbon feed line. One or more or all of the feed lines may also be suitable for feeding in two or more group members, for example a natural gas/syngas/coke oven gas feed line.

The presence of the feed lines, and mixing devices where required, allows members of the second group to be added to the top gas and/or to the treatment gas.

In a preferred embodiment, the reduction reactor has a cooling zone and/or a product cooler, and an ammonia supply line leads into the cooling zone and/or the product cooler.

The present application further provides a signal processing means having a machine-readable program code, characterized in that it includes closed-loop control commands for carrying out a process of the invention. It also provides a signal processing means for carrying out the process as claimed in any of claims 1 to 7. The signal processing means is part of an open-loop and/or closed-loop control of a device for reducing metal-oxide-containing material.

The present application further provides a machine-readable program code for a signal processing means that is part of an open-loop and/or closed-loop control of a device for reducing metal-oxide-containing material, characterized in that the program code includes closed-loop control commands that cause the signal processing means to carry out a process of the invention. The invention further provides a computer program product including commands for a signal processing means that is part of an open-loop and/or closed-loop control of a device for reducing metal-oxide-containing material and that, when the program for the signal processing means is executed, causes it to carry out the process as claimed in any of claims 1 to 7.

The present application further provides a storage medium having a machine-readable program code of the invention stored thereon. It also provides a storage medium having a computer program for carrying out the process as claimed in any of claims 1 to 7 stored thereon.

The present application further provides an open-loop and/or closed-loop control of a device for reducing metal-oxide-containing material with a computer containing a computer program product including commands that, when the computer program is executed by the computer, cause the computer to execute the steps of a process as claimed in any of claims 1 to 7.

The present application further provides a computer program product including commands that, when the computer program is executed by a computer, cause the computer to execute the steps of a process as claimed in any of claims 1 to 7. The present application further provides a computer-readable data carrier on which such a computer program product is stored.

### BRIEF DESCRIPTION OF THE DRAWINGS

The present invention will be described by way of example hereinbelow with reference to several schematic figures.

FIG. 1 shows in schematic form the performance of a variant of the process of the invention in a variant of the device of the invention for reducing metal-oxide-containing material.

FIG. 2 shows a further variant in schematic form.

FIG. 3 shows a further variant.

FIG. 4 shows a further variant in schematic form.

FIG. 5 shows a further variant in schematic form.

### DESCRIPTION OF THE EMBODIMENTS

### Examples

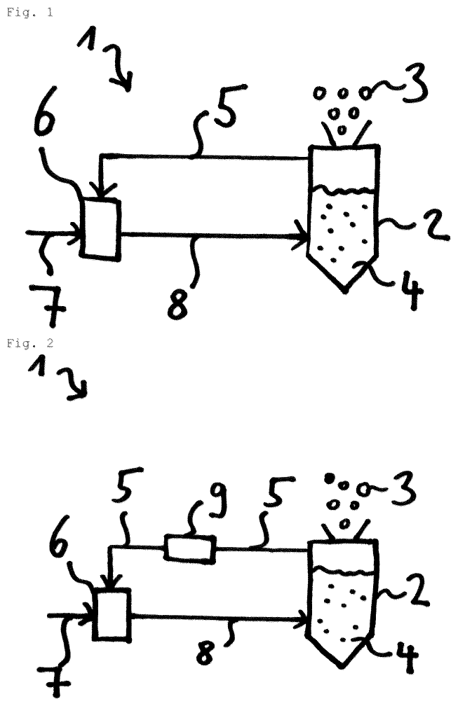

FIG. 1 shows in schematic form the performance of a process of the invention in a device of the invention 1 for reducing metal-oxide-containing material. Metal-oxide-containing material 3, in this case iron-oxide-containing material, is introduced into a reduction reactor 2, in this case a reduction shaft, where it forms a fixed bed 4. A reducing gas is used to reduce the metal-oxide-containing material 3 in the reduction reactor 2. Top gas is discharged from the reduction reactor 2 via top gas discharge line 5. The top gas discharge line 5 leads into the preparation unit 6 for preparing the reducing gas. An inlet line for the ammonia input 7 leads into the preparation unit 6. In the preparation unit 6, reducing gas is prepared with the use of ammonia NH₃ and with the use of top gas as a component. The reducing gas obtained with the use of ammonia and top gas is supplied to the reduction reactor 2 containing the metal-oxide-containing material 3 via the supply line 8. In the preparation unit 6, top gas is mixed with ammonia and the resulting gas mixture is the reducing gas. The top gas is thus used directly in the preparation of the reducing gas.

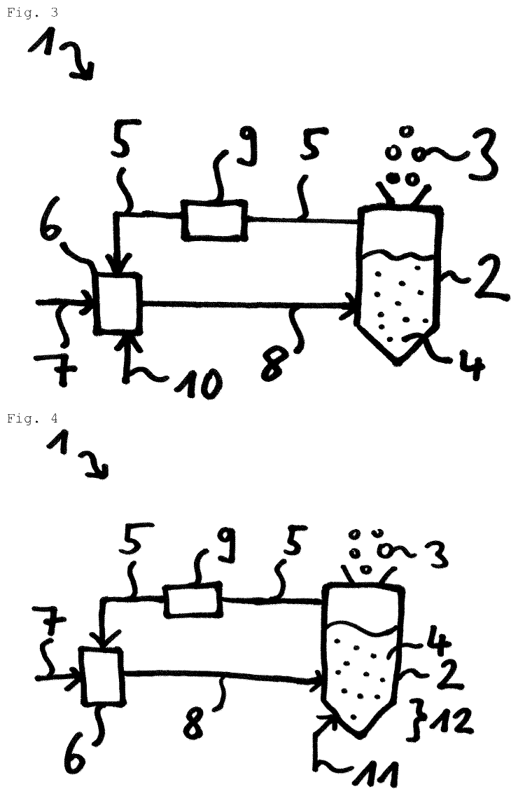

FIG. 2 shows in schematic form a variant largely analogous to FIG. 1, in which the top gas is used indirectly in the preparation of the reducing gas. The preparation unit 6 is supplied with treatment gas via the top gas discharge line 5. The treatment gas is obtained by the treatment of the top gas; in the top gas discharge line 5 there is a device for lowering the nitrogen content 9—a stream of treatment gas depleted in nitrogen is supplied to the preparation unit 6 via the top gas discharge line 5. In the preparation unit 6, the treatment gas is mixed with ammonia and the resulting gas mixture is the reducing gas. In FIG. 2, the lowering of the nitrogen content thus results in a part-amount of the top gas being used as a component in the preparation of the reducing gas.

FIG. 3 shows in schematic form a variant largely analogous to FIG. 2, in which the preparation unit 6 includes a feed line for natural gas 10. This makes it possible to admix natural gas with the gas mixture obtained after combining treatment gas and ammonia, or to admix ammonia with the gas mixture obtained after combining treatment gas and natural gas. The gas mixture thereby obtained can serve as a reducing gas precursor and be converted into a reducing gas in a reformer (not specifically shown).

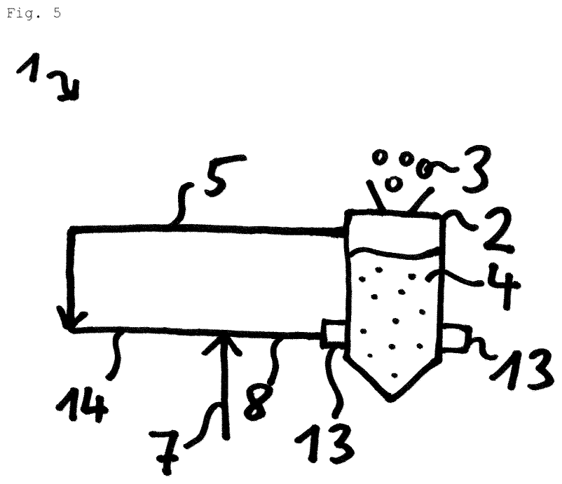

FIG. 4 shows in schematic form a variant largely analogous to FIG. 2, in which an ammonia supply line 11 leads into the cooling zone 12 of the reduction reactor 2. This allows ammonia to be introduced into the cooling zone during direct reduction in the reduction reactor 2.

FIG. 5 shows in schematic form a variant largely analogous to FIG. 1, in which the bustle 13 of the reduction reactor is also shown. Reducing gas is supplied to the bustle 13 via supply line 8. For the preparation of the reducing gas, ammonia is supplied to the top gas conduit 14 via an inlet line for the ammonia input 7. The supply line 8 also counts here as a preparation unit and mixing device, since ammonia and top gas are mixed therein.

### LIST OF REFERENCE SIGNS

1 Device for reducing metal-oxide-containing material
2 Reduction reactor
3 Metal-oxide-containing material
4 Fixed bed
5 Top gas discharge line
6 Preparation unit
7 Inlet line for ammonia input
8 Supply line
9 Device for lowering the nitrogen content
10 Feed line for natural gas
11 Ammonia supply line
12 Cooling zone
13 Bustle
14 Top gas conduit

1. A process for reducing metal-oxide-containing material,
wherein a reducing gas obtained with the use of ammonia NH₃ is employed,
wherein the reducing gas is supplied to a reduction reactor containing the metal-oxide-containing material,
and a top gas is discharged from the reduction reactor, wherein
at least a part-amount of the top gas, optionally after a treatment of the top gas,
is used as a component in the preparation of the reducing gas.

2. The process as claimed in claim 1, wherein the treatment of the top gas withdrawn from the reduction reactor includes a process step to lower the nitrogen content.

3. The process as claimed in claim 1, wherein at least one member of the first group consisting of:
ammonia,
hydrogen obtained from ammonia,
is added to the top gas and/or to the treatment gas during the preparation of the reducing gas.

4. The process as claimed in claim 1, wherein at least one member of the second group consisting of:
natural gas,
hydrocarbons,
hydrogen,
carbon monoxide,
coke oven gas,
syngas comprising two or more constituents from the group of constituents consisting of CO, H₂, CH₄, C2-C6 hydrocarbons, N₂, CO₂,
is added to the top gas and/or to the treatment gas during the preparation of the reducing gas.

5. The process as claimed in claim 4, wherein at least one member of the second group is added to the gas mixture obtained after combining the top gas or treatment gas and at least one member of the first group.

6. The process as claimed in claim 4, wherein at least one member of the first group is added to the gas mixture obtained after combining the top gas or treatment gas and at least one member of the second group.

7. The process as claimed in claim 1, wherein it is carried out in a reduction reactor having a cooling zone and/or a product cooler, wherein
ammonia is introduced into the cooling zone of the reduction reactor and/or into the product cooler.

8. A device for reducing metal-oxide-containing material, comprising:
a reduction reactor,
a top gas discharge line for discharging top gas from the reduction reactor,
at least one inlet line for the ammonia input,
a preparation unit for preparing the reducing gas,
into which leads at least one inlet line for the ammonia input,
a supply line for the supply of the reducing gas and/or of a reducing gas precursor to the reduction reactor, wherein
the top gas discharge line leads into the preparation unit.

9. The device as claimed in claim 8, wherein the top gas discharge line includes at least one treatment unit that is a device for lowering the nitrogen content.

10. The device as claimed in claim 8, wherein the preparation unit includes at least one feed line for feeding in one or more members of the group consisting of:
natural gas,
hydrocarbons,
hydrogen,
carbon monoxide,
coke oven gas,
syngas.

11. The device as claimed in claim 8, wherein the reduction reactor has a cooling zone and/or a product cooler, wherein an ammonia supply line leads into the cooling zone and/or the product cooler.

12. A signal processing means comprising a non-transitory medium having recorded thereon a machine-readable program code, wherein the code includes closed-loop control commands for carrying out a process as claimed in claim 1.

13. A computer product comprising a non-transitory computer-readable medium that has recorded thereon machine-readable program code for a signal processing means, wherein the program code includes closed-loop control commands that cause the signal processing means to carry out a process as claimed in claim 1.

14. (canceled)

15. An open-loop and/or closed-loop control of a device for reducing metal-oxide-containing material with a computer containing a computer program product including commands that, when the computer program is executed by the computer, cause the computer to execute the steps of a process as claimed in claim 1.
